(19) United States
(12) Patent Application Publication
(10) Pub. No.: US 2023/0356515 A1
(43) Pub. Date: Nov. 9, 2023

(54) PAPER-BASED, BIO-BASED PLASTIC LAMINATING PACKAGING MATERIAL

(71) Applicant: NEUROPACK Co., Ltd., Wonju-si, Gangwon-do (KR)

(72) Inventor: Eui Suk KO, Seoul (KR)

(73) Assignee: NEUROPACK Co., Ltd., Wonju-si, Gangwon-do (KR)

(21) Appl. No.: 18/042,979

(22) PCT Filed: Nov. 26, 2020
(86) PCT No.: PCT/KR2020/016921

§ 371 Date: Feb. 24, 2023

(30) Foreign Application Priority Data
Nov. 25, 2020 (KR) 10-2020-0160070

(51) Int. Cl. B32B 27/10; B32B 27/32; B65D 65/40; B32B 27/18; B65D 65/46; C08L 23/06; C09D 175/04

(52) U.S. Cl. CPC B32B 27/10; B32B 27/32; B65D 65/40; B32B 27/18; B65D 65/466; C08L 23/06; C09D 175/04; B32B 2553/00; B32B 2307/7244; B32B 2307/7246; B32B 2255/12; B32B 2255/26; B32B 2307/7163; B32B 2307/54; B32B 2250/03; B32B 2250/40

(57) ABSTRACT

The present invention relates to a paper-based, bio-based plastic laminating packaging material, more particularly, comprising: a paper (1) having barrier properties against oxygen and moisture; a barrier layer (2) formed on both sides of the paper (1); and a bio-polyethylene layer (3) stacked on either or both of the barrier layers (2). According to the present invention, compared with conventional petroleum-derived plastic products, the physical properties do not deteriorate, environmental pollution can be prevented, and barrier properties are excellent against moisture and oxygen.

### BACKGROUND

### Technical Field

The present invention relates to a paper-based and bio-based plastic laminating packaging material, and more specifically, to a paper-based and bio-based plastic laminating packaging material capable of preventing environmental pollution without deteriorating physical properties compared to conventional petroleum-derived plastic products and aluminum-containing products by laminating paper and bio-polyethylene.

### Background Art

Recently, with the development of modern industries, diversification and marketability of various products are important, and consumer demand for convenience in handling and quality maintenance is gradually increasing in production, storage, distribution, and packaging for sales of products.

Therefore, with such social environment, in the packaging material industry field, moving away from the passive purposes for simply protecting products and maintaining quality, people try to provide active effects to packaged products according to the characteristics of products, and are thus making active efforts to provide functional factors to packaging materials and increase marketability.

Today, plastic packaging materials have been developed to have lightness, excellent gas barrier properties, moisture barrier properties, stretchability, processability, and the like as packaging materials in various food products, medicines, electronic and optical fields, and daily supplies.

Meanwhile, in the case of food, cosmetics, medicines, electronic products, etc. which are sensitive to moisture, it is necessary to maintain the inside of a packaged product in a dry state because water activity may cause a change in physical properties of the product, acidification, nutritional loss, deterioration of organoleptic value, and decomposition by microbial growth.

In general, in order to solve such problems, that is, in order to block moisture and oxygen, aluminum or an aluminum deposition film is laminated on a general plastic film to manufacture packaging materials, or an inorganic material is coated on a film using ethyl vinyl alcohol (EVOH), polyvinylidene chloride (PVDC), nylon, polyester, or the like, which are moisture barrier synthetic polymers, to manufacture packaging materials.

However, as described above, in a case in which an aluminum material is included in the packaging material, it is impossible to recycle the packaging material. Moreover, since the packaging material including the aluminum material and the packaging material including the moisture barrier synthetic polymer are not decomposed after being thrown out in a general natural state, it causes a serious environmental pollution. Due to these problems, there is a growing need for a plastic-free packaging material.

Therefore, there is a need for a packaging material that does not include an aluminum material, has sufficient blocking properties to protect deterioration of the contents inside the packaging material, and is biodegradable in a natural state.

As conventional arts in the art to which the present disclosure pertains, there are Korean Patent No. 10-1240684, Korean Patent No. 10-2159935, and Korean Patent No. 10-1559044.

### DETAILED DESCRIPTION OF THE INVENTION

### Technical Problem

The present disclosure has been made to solve the above-mentioned problems occurring in the prior art, and in an aspect of the present disclosure, an object of the present disclosure is to provide a paper-based and bio-based plastic laminating packaging material, which does not deteriorate physical properties compared to a conventional petroleum-derived plastic product, can prevent environmental pollution, does not include an aluminum material, and has excellent moisture and oxygen barrier properties.

### Technical Problem

To accomplish the above-mentioned objects, according to an aspect of the present disclosure, there is provided a paper-based and bio-based plastic laminating packaging material including: a paper having excellent barrier properties against oxygen and moisture; barrier layers formed on both surfaces of the paper; and a bio-polyethylene layer stacked on either or both of the barrier layers.

The bio-polyethylene layer includes: starch-based biomass derived from plant sources, cellulose-based biomass derived from plant sources, or both thereof; wax; a surfactant; a starfish protein extract; shungite powder; and polyethylene.

The bio-polyethylene layer further includes cocofiber and bagasse.

The barrier layer includes: 20 to 50 wt % of vegetable polyol, 20 to 50 wt % of diisocyanate, 5 to 10 wt % of chain extender, and the balance of organic solvent.

### Advantageous Effects

The paper-based and bio-based plastic laminating packaging material according to the present disclosure can prevent environmental pollution without deteriorating physical properties compared to conventional petroleum-derived plastic products, and have excellent moisture and oxygen barrier properties.

### BRIEF DESCRIPTION OF THE DRAWINGS

FIG. 1 is a cross-sectional view illustrating a packaging material according to an embodiment of the present disclosure.

FIG. 2 is a cross-sectional view illustrating a packaging material according to another embodiment of the present disclosure.

### MODE FOR THE INVENTION

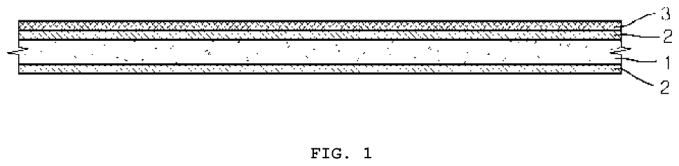

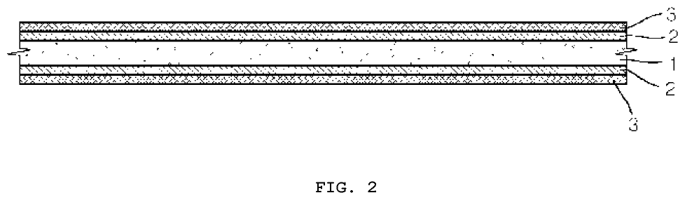

Hereinafter, the present disclosure will be described in detail with reference to FIGS. 1 and 2.

The largest feature of the present disclosure is to manufacture a packaging material by laminating paper and a bio-polyethylene layer, thereby providing a packaging material having excellent eco-friendliness, and excellent moisture and oxygen barrier properties without deteriorating physical properties compared to conventional petroleum-derived plastic products.

As illustrated in FIGS. 1 and 2, the packaging material of the present disclosure includes: a paper (1) having barrier properties against oxygen and moisture, barrier layers (2) formed on both surfaces of the paper (1), and a bio-polyethylene layer (3) stacked on either or both of the barrier layers (2).

The paper (1) provides barrier properties against moisture, oxygen, and ultraviolet rays to the packaging material, and may be substituted for conventional oxygen and moisture barrier layers, that is, a film layer made of aluminum, ethyl vinyl alcohol (EVOH), polyvinylidene chloride (PVDC), nylon, polyester, or the like, which is not biodegradable and is difficult to recycle. So, the paper (1) is biodegradable by microorganisms or the like, and thus the packaging material is eco-friendly.

The barrier layers (2) are formed on both surfaces of the paper (1) to suppress oxygen and moisture permeability of the paper (1), and may be formed of at least one of an acrylic resin, a modified acrylic resin, a urethane resin, and a modified urethane resin known in the art. That is, the paper (1) having the barrier layers (2) has improved barrier properties against oxygen and moisture.

In the present disclosure, barrier properties against oxygen and moisture may be controlled by adjusting the basis weight of the paper (1) and the thickness of the barrier layer (2), and the basis weight of the paper (1) may be 30 to 300 g/m², and the thickness of the barrier layer (2) may be 1 to 50 μm.

The bio-polyethylene layer (3) is laminated on one or both of the barrier layers (2) formed on both surfaces of the paper (1).

The bio-polyethylene layer (3) means what is comprised of polyethylene including biomass as a raw material, and has an effect of suppressing an increase of the concentration of carbon dioxide in the atmosphere and reducing the consumption of petroleum, a limited resource, by using plant resources in which carbon in the air is fixed by photosynthesis as a raw material, and being environmentally friendly since it is decomposed by microorganisms after disposal.

In the present disclosure, in a case in which the bio-polyethylene layer (3) includes 10 to 90 wt % of biomass, the kind of the bio-polyethylene layer (3) is not limited thereto.

Since the bio-polyethylene layer (3) may have a thickness of 10 to 300 μm, if the thickness of the bio-polyethylene layer (3) is too thick, the bio-polyethylene layer (3) cannot bear sealing strength and heavy packaging, and the cost of the bio-polyethylene layer (3) is increased more than necessary.

The packaging material configured as described above has the advantage of not causing environmental pollution since the paper (1) and the bio-polyethylene layer (3) are effectively decomposed by microorganisms. In addition, since the packaging material is formed by laminating the bio-polyethylene layer (3) on the basis of the paper (1), the packaging material can prevent degradation of physical properties occurring when the conventional bio-plastic is used alone, and improve oxygen and moisture permeability.

The oxygen and moisture permeability of the packaging material according to the present disclosure may vary depending on the kind and thickness of the used paper (1), the barrier layer (2), and the bio-polyethylene layer (3), but the oxygen permeability of the packaging material may be 0.01 to 50 cc/m², and the moisture permeability is in the range of 0.01 to 50 g/m².

In addition, in the present disclosure, the method of forming the barrier layer (2) on the paper (1) and laminating it on the bio-polyethylene layer (3) is achieved by the well-known method or the method of laminating by coating, by a thermal layer, by an adhesive, or the like, and a detailed description thereof is omitted, and the method is not limited thereto.

Meanwhile, as the content of biomass was increased, the bio-polyethylene layer (3) may be deteriorated in mechanical properties such as tensile strength compared to a general plastic film. In addition, in a case in which the content of biomass is low, biodegradability is deteriorated, and it requires a long period of time in decomposition.

In order to solve the above problem, preferably, the bio-polyethylene layer (3) is composed as follows.

That is, the bio-polyethylene layer (3) includes: starch-based biomass derived from plant sources, cellulose-based biomass derived from plant sources, or both thereof; wax; a surfactant; a starfish protein extract; shungite powder; and polyethylene. More specifically, the film layer includes: 10 to 70 wt % of starch-based biomass derived from plant sources, cellulose-based biomass derived from plant sources, or both thereof; 5 to 10 wt % of wax; 0.5 to 5 wt % of a surfactant; 0.5 to 5 wt % of a starfish protein extract; 0.5 to 5 wt % of shungite powder; and the balance of polyethylene. The composition ratio is limited as the above in consideration of biodegradability, antibiosis, and mechanical properties of the film.

The biomass may include at least one of starch-based biomass derived from plant sources and cellulose-based biomass derived from plant sources, and most preferably, all thereof. Specifically, the starch-based biomass derived from plant sources may be corn starch, potato starch, sweet potato starch, cassava starch, or modified starch thereof, for example, may be starch selected from oxidized starch, cationic starch, cross-linkage starch, starch ester, and a combination thereof, or may be plant powder selected from flour, corn flour, rice flour, glutinous rice flour, potato flour, sweet potato flour, cassava powder, and a combination thereof.

In addition, the cellulose-based biomass derived from plant sources may be wood fiber, cotton fiber, grass fiber, reed fiber, bamboo fiber, or a modifier thereof, or may be selected from, for example, carboxymethyl cellulose, carboxyethylcellulose, cellulose ester, cellulose ether, and a combination thereof.

Because the starch-based biomass forms a particle phase on the basis of hydrogen bonding and is a hydrophilic material having a moisture content of 10 to 13% and excellent moisture adsorption due to a hydroxyl group attached to a glucose unit, it does not show flowability even though moisture is applied thereof, causes carbonization in a range of about 220° C., does not cause polymer bonding, and is deteriorated in mechanical properties due to weak interfacial adhesive force. Therefore, in order to solve the above problems, the cellulose-based biomass may be used together to prevent binding and carbonization, to be resistant to alkali and chemicals, and not to be eroded by microorganisms. Therefore, it is the most preferable that the starch-based biomass and the cellulose-based biomass are used in a weight ratio of 10:1 to 5. In addition, the particle size of the biomass is not limited.

The wax serves to connect biomass and polyethylene, and may be one or more selected from paraffin wax, liquid paraffin wax, beeswax, mortar wax, candelilla wax, polyethylene wax, and polypropylene wax, but is not limited thereto.

The surfactant is to uniformly mix the biomass, the shungite powder, and the like with polyethylene, and may be any one or more selected from fatty acids such as stearic acid, myristic acid, palmitic acid, arachidic acid, oleic acid, linolenic acid, and curing fatty acid, and polyol series such as glycerin, butylene glycol, propylene glycol, dipropylene glycol, pentylene glycol, hexylene glycol, polyethylene glycol, and sorbitol, but is not limited thereto.

Starfish protein extract improves tensile strength of the bio-polyethylene layer (3), increases biodegradability, and also improves antibacterial properties. The method of extracting protein from starfish may be obtained by the conventional art, and the embodiment is not limited thereto.

The shungite powder is a material having SiO₂ (silicate) and C₆₀ (fullerene) as major ingredients, and is used as an inorganic filler. The shungite has an antioxidant function, an electromagnetic wave blocking function, a pollutant purification and decomposition function, and a sterilization and antibacterial function, provides antibacterial properties to a packaging material, and blocks electromagnetic waves to facilitate packaging of an electronic product. In addition, the shungite also increases barrier properties against oxygen and moisture. In the present disclosure, the shungite powder may be elite shungite or normal shungite, and the kind of the shungite powder is not limited, and the particle size thereof is about 0.1 to 5 μm.

Furthermore, the polyethylene is main resin of the bio-polyethylene layer (3), and may be used regardless of the kinds of LDPE, HDPE, and the like.

As described above, the bio-polyethylene layer (3) including: 10 to 70 wt % of starch-based biomass derived from plant sources, cellulose-based biomass derived from plant sources, or both thereof; 5 to 10 wt % of wax; 0.5 to 5 wt % of surfactant; 0.5 to 5 wt % of a starfish protein extract; 0.5 to 5 wt % of shungite powder; and the balance of polyethylene has excellent biodegradability and antibiosis, and improves mechanical properties, such as tensile strength.

On the other hand, the bio-polyethylene layer (3) may further include cocofiber and bagasse. That is, the bio-polyethylene layer (3) consists of: 10 to 70 wt % of starch-based biomass derived from plant sources, cellulose-based biomass derived from plant sources, or both thereof; 5 to 10 wt % of wax; 0.5 to 5 wt % of surfactant; 0.5 to 5 wt % of a starfish protein extract; 0.5 to 5 wt % of shungite powder; 0.1 to 1 wt % of cocofiber; 0.1 to 1 wt % of bagasse; and the balance of polyethylene.

The cocofiber is a fibrous layer of coconut fruit, is a natural material without environmental damage since being naturally decomposed by microorganisms, and is naturally reduced to organic fertilizer. In addition, the cocofiber improves the mechanical properties of the packaging material (3) since having strong physical properties.

The bagasse is residue remaining after squeezing sucrose from the stem of a sugar cane, and acts as a natural adhesive and provides antibacterial properties since including a large amount of polyphenol. Therefore, the bagasse improves physical properties of the bio-polyethylene layer (3), and provides antibacterial properties.

Meanwhile, the present disclosure is a packaging material which is composed of a biodegradable raw material and is naturally decomposed by microorganisms when the persisting period is terminated. Preferably, the barrier layer (2) is also formed of bio-polyurethane.

The bio-polyurethane is composed of a urethane reactant of a composition including: 20 to 50 wt % of vegetable polyol, 20 to 50 wt % of diisocyanate, 5 to 10 wt % of chain extender, and the balance of organic solvent. The vegetable polyol may include at least one selected from soybean oil, corn oil, castor oil, rapeseed oil, coconut oil, olive oil, sesame oil, sugar cane oil, sunflower oil, palm oil, and the like, and is used as a polyol ingredient which is active hydrogen compound used to manufacture polyurethane by reacting with isocyanate.

The diisocyanate may be an aromatic-based isocyanate including at least one selected from toluene diisocyanate (TDI), 4,4-diphenylmethane diisocyanate (MDI), p-phenylene diisocyanate (PPDI), and xylene diisocyanate (XDI), but the kind thereof is not limited thereto.

The chain extender may be commonly used in the art, but may be preferably at least one selected from: a glycol group including at least one selected from ethylene glycol, 1,4-butylene glycol, 1,6-hexamethylene glycol, and 1,3-propanediol; and a diamine group including at least one selected from ethylene diamine (EDA), 4,4-diphenyl methane diamine (MDA), and isophorone diamine (IPDA).

Furthermore, organic solvent commonly used in the art may be used, and may include at least one among methylethylketone, acetone, diethylketone, and methylisobutylketone.

As described above, in a case in which the barrier layer (2) is formed using the bio-polyurethane, there is an advantage in that the carbon dioxide reduction rate and biodegradability of the packaging material are further improved.

The packaging material of the present disclosure is applicable as packaging materials for medicines, cosmetics, foods, electronic products, and various industrial materials, and may be utilized as various film packaging materials as well as a conventional tube including aluminum, and is not limited in use ranges.

Hereinafter, the present disclosure will be described in more detail with reference to specific embodiments.

### Embodiment 1

Paper having a basis weight of 150 g/m² was prepared, biopolyurethane was cast on both surfaces of the paper. The paper was primarily dried at 80° C. for 30 seconds, and then, secondarily dried at 150° C. for 30 seconds to form a barrier layer. In this instance, a thickness of the barrier layer was 20 μm.

In this instance, the bio-polyurethane was prepared by mixing 25 wt % of castor oil (Mw=2,022), 35 wt % of 4,4-diphenylmethane diisocyanate (MDI), 5 wt % of 1,3-propanediol, and the balance of methylethylketone, and performing urethane reaction.

Thereafter, a bio-polyethylene layer having a thickness of 100 μm was laminated to all of the two barrier layers.

In this instance, a composite consisting of 50 wt % of biomass formed by mixing starch-based biomass derived from plant sources (corn powder) and cellulose-based biomass derived from plant sources (carboxyethylcellulose) at a weight ratio of 10:3; 5 wt % of polyethylene wax; 4 wt % of glycerin; 3 wt % of starfish protein extract; 3 wt % of shungite powder; and the balance of HDPE was sufficiently mixed at 200° C. to prepare a polyethylene film, and the polyethylene film was laminated onto the barrier layer. The particle size of the protein extracted from the biomass, the shungite powder, and the starfish was 0.1 to 3 μm.

The starfish protein extract was prepared as follows.

Dried Asterias amurensis was pulverized, and then, was sorted using a 30 mesh sieve. 400 g of the sorted starfish and 0.1M sodium hydroxide were mixed at a ratio of 1:6 (w/v), and then, was stirred for 1 hour. After stirring, a precipitate obtained by performing centrifugation at 10,000×g for 20 minutes was washed with tap water. After washing, 0.5% of tartaric acid was added and stirred for one hour, and then, a precipitate obtained by performing centrifugation at 10,000×g for 20 minutes was washed with tap water. After washing, the precipitate was homogenized at 6 pH with 1M tartaric acid for 30 minutes using an ultrasonicator, and then, was stirred at 80° C. for three hours. Thereafter, supernatant was obtained through centrifugation, and then, was freeze-dried to obtain protein.

### Embodiment 2

The embodiment 2 was carried out in the same manner as the embodiment 1, 1 wt % of coco-fiber and 1 wt % of bagasse were added to manufacture a polyethylene film. In this instance, the particle size of coco-fiber and bagasse was 0.1 to 3 μm.

### Example 1

Oxygen transmission rate (OTR) and water vapor transmission rate (WVTR) of the packaging materials prepared in embodiments 1 and 2 were measured and the result is illustrated in Table 1 below.

The oxygen permeability was expressed in an amount of oxygen passing through the packaging material for 24 hours under conditions of temperature of 23±1° C. and O₂ concentration of 100%, and was measured using an oxygen permeability tester. The moisture permeability was expressed in an amount of water vapor passing through the packaging material for 24 hours under conditions of temperature of 37±1° C. and humidity of 100%, and was measured using a vapor permeability tester.

TABLE 1
Result of Example 1

| Division | Embodiment 1 | Embodiment 2 |
|---|---|---|
| OTR (cc/m² · day) | 0.54 | 0.59 |
| WVTR (g/m² · day) | 0.98 | 0.99 |

As shown in Table 4, embodiments 1 and 2 of the present disclosure showed excellent oxygen permeability and moisture permeability. In addition, the oxygen permeability and the moisture permeability may be adjusted to 0.1 to 50 cc/m².day and 0.1 to 50 g/m².day by respectively adjusting the thickness and composition ratio of the paper, the barrier layer, and the bio-polyethylene layer. 0.1 to 50 g/m² per day.

### Example 2

A biodegradable test of the packaging material prepared by the embodiments 1 and 2 was performed. The test was performed according to the ASTM D6954-04 method. The result is shown in Table 2 below.

TABLE 2
Result of Example 2

| | Average biodegradability calculated by CO2 emission | | |
|---|---|---|---|
| Classification | Standard material | Embodiment 1 | Embodiment 2 |
| % (unit) | 76.1 | 48.7 | 52.2 |

As illustrated in Table 2, it was confirmed that the average biodegradability calculated by the carbon dioxide emission of cellulose, which is a standard material, was 76.1%, and embodiments 1 and 2 prepared according to the present disclosure had excellent biodegradability as 48.7% and 52.2%, respectively.

### Example 3

Tensile strength of the bio-polyethylene film prepared according to embodiments 1 and 2 was measured. The tensile strength was measured using a universal material tester (WL2100C UTM, Withlab Corporation, Gunpo, Korea) by cutting the film to 5×150 mm according to ASTM D3039 rule, and the result is illustrated in Table 3 below. As a control, a commercially available Bio PE film was used.

TABLE 3
Result of Example 3

| | Control | | Embodiment 1 | | Embodiment 2 | |
|---|---|---|---|---|---|---|
| Classification | MD | TD | MD | TD | MD | TD |
| Tensile | 3.112 | 2.424 | 4.125 | 2.825 | 4.162 | 2.852 |
| Strength | | | | | | |
| (kgf/mm²) | | | | | | |

As shown in Table 3, it was confirmed that the bio-polyethylene films of embodiments 1 and 2 according to the present disclosure were significantly improved in tensile strength compared to the control.

### Example 4

The antimicrobial properties of the packaging material prepared in embodiments 1 and 2 were tested. The result is shown in Table 4 below.

TABLE 4
Result of Example 4

| | | Blank | Embodiment | Embodiment |
|---|---|---|---|---|
| Classification | | Law | 1 | 2 |
| Strain | Bacterial count after | 1.0 × 10⁴ | — | — |
| 1 | inoculation | | | |
| | Bacterial count after | 2.5 × 10⁴ | 3.2 × 10² | <0.63 |
| | 24 hours | | | |
| | Antimicrobial activity | — | 1.8 | 4.5 |
| Strain | Bacterial count after | 1.0 × 10⁴ | — | — |
| 2 | inoculation | | | |
| | Bacterial count after | 1.0 × 10⁶ | <0.63 | <0.63 |
| | 24 hours | | | |
| | Antimicrobial activity | — | 6.1 | 6.1 |

Test method: JIS Z 2801: 2010, film adhesion: bacterial count/cm², antibacterial activity log
Standard film: Stomacher ® 400 POLY-BAG
Test conditions: Measured bacterial count after incubating a test solution at (35 ± 1) ° C. and 90% R.H. for 24 hours
Antibacterial effect: antibacterial activity of 2.0 or more
Use of strain: Strain 1-Staphylococcus aureus ATCC 6538P strain 2-Escherichia coli ATCC 8739

As shown in Table 4, it was confirmed that the packaging materials of embodiments 1 and 2 according to the present disclosure had excellent antibacterial properties.

Although a preferred embodiment of the present disclosure has been described, it will be understood by one of ordinary skill in the art that the present disclosure may be practiced in other specific forms without altering the technical spirit or essential features thereof. Therefore, the above-described embodiments should be considered only as examples in all aspects and not for purposes of limitation.

Explanation of Code
1: paper 2: barrier layer
3: bio-polyethylene layer

1. A paper-based and bio-based plastic laminating packaging material comprising:
a paper having barrier properties against oxygen and moisture;
barrier layers formed on both surfaces of the paper; and
a bio-polyethylene layer stacked on either or both of the barrier layers

2. The paper-based and bio-based plastic laminating packaging material according to claim 1, wherein the bio-polyethylene layer includes: starch-based biomass derived from plant sources, cellulose-based biomass derived from plant sources, or both thereof; wax; surfactant; starfish protein extract; shungite powder; and polyethylene.

3. The paper-based and bio-based plastic laminating packaging material according to claim 2, wherein the bio-polyethylene layer further includes cocofiber and bagasse.

4. The paper-based and bio-based plastic laminating packaging material according to claim 1, wherein the barrier layer includes: to 50 wt % of vegetable polyol, 20 to 50 wt % of diisocyanate, 5 to 10 wt % of chain extender, and the balance of organic solvent.
